(19) United States
(12) Patent Application Publication
(10) Pub. No.: US 2026/0342370 A1
(43) Pub. Date: Oct. 29, 2026

(54) UPLINK PASSIVE INTERMODULATION (PIM) EIGEN-CANCELLER

(71) Applicant: Telefonaktiebolaget LM Ericsson (publ), Stockholm (SE)

(72) Inventors: Pierre-Andre LAPORTE, Gatineau (CA); Bo GÖRANSSON, Sollentuna (SE); Mark WYVILLE, Ottawa (CA)

(73) Assignee: Telefonaktiebolaget LM Ericsson (publ), Stockholm (SE)

(21) Appl. No.: 19/107,035

(22) PCT Filed: Sep. 30, 2022
(86) PCT No.: PCT/IB2022/059358

§ 371 Date: Feb. 27, 2025

(51) Int. Cl. H04B 1/10

(52) U.S. Cl. CPC H04B 1/1027

(57) ABSTRACT

A method and network node for uplink passive intermodulation (PIM) eigen-cancellation are disclosed. According to one aspect, a method in a network node includes determining an uplink PIM covariance matrix. The method also includes determining an uplink PIM signal subspace matrix based at least in part on an eigen-decomposition of the uplink PIM covariance matrix, the uplink PIM signal subspace matrix spanning an uplink PIM signal subspace. The method further includes determining a residual uplink signal vector at least partially compensated for PIM based at least in part on a spatial projection of a total received uplink signal vector onto the uplink PIM signal subspace.

### TECHNICAL FIELD

The present disclosure relates to wireless communications, and in particular, to an uplink passive intermodulation (PIM) eigen-canceller.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Passive Inter-Modulation (PIM) is an important concern for cellular operators as more downlink channels are being transmitted from the cellular radio sites. To add to the challenge, the newly introduced radio channels belong to a rising number of radio bands which increases the odds of having passive inter-modulations desensitizing the uplink receivers.

Traditional techniques include sending a technician to the cellular site to attempt to reduce PIM sources, as well as PIM-Cancellation, which uses active noise reduction principles to adapt a non-linear model in real-time, in which a time-domain replica of the PIM signal is subtracted from the received waveforms for each antenna.

The problem with time-domain PIM-Cancellation techniques is that the number of non-linear terms that must be generated depends on the parameters listed below:
Downlink (DL) signal combinations (DL antennas, polarity, frequency, delayed signal cross-terms);
Number of uplink (UL) antennas;
Number of UL channels;
Non-linear order; and
Number of intermodulation (IM) bands involved.

The number of non-linear terms that have to be generated increases exponentially for some of the parameter combinations. In addition, these non-linear terms must be generated at a larger sampling rate to avoid spectral aliasing, resulting in a very large implementation cost which may prohibit the use of this technique for antenna arrays.

The problem with sending a technician to the cellular site is the high cost combined with the fact that it may not always possible to solve the problem of PIM for active antenna systems (AAS). Indeed, large antenna gain may under some circumstances that are dictated by the beamforming weights, excite PIM sources which cannot be removed from the environment such as a lamp post or a metallic handrail. In this situation, some active PIM mitigation techniques must be used.

### SUMMARY

Some embodiments advantageously provide methods and a network node, for an uplink passive intermodulation (PIM) eigen-canceller.

Some embodiments described herein mitigate PIM by steering uplink nulls in the antenna domain of AAS radios. This PIM null steering may be done independently in the radio, without interacting with the baseband receiver algorithm.

Some embodiments include an uplink PIM spatial avoidance method where nulls are steered in the antenna domain for large antenna arrays.

Some advantages of some embodiments of the PIM eigen-canceller disclosed herein may include one or more of the following:
Some PIM eigen-canceller methods disclosed herein are agnostic of the following parameters:
   The order of the non-linear terms involved;
   The number of DL signal combinations (polarity, frequency, delayed signal cross-terms); and
   The number of intermodulation bands involved.
Some PIM eigen-canceller methods disclosed herein are implemented at the baseband rate which helps maintaining a low implementation cost. The null-steering actuator complexity scales linearly with the bandwidth and the number of antenna ports:
   The covariance matrix eigen decomposition complexity scales with O(N_ant\hat{ }3). However, the PIM eigenvectors refresh rate may be much slower than the NR/LTE orthogonal frequency division multiplex (OFDM) symbol rate. Thus, in some embodiments, the PIM eigenvector acquisition has a low relative computational cost compared to that of the null-steering actuator; and/or
Scalability: some algorithms disclosed herein may be configured to support multiple deployment scenarios (i.e., different numbers of antenna ports and UL channels).

According to one aspect, a method in a network node is provided. The method includes determining an uplink passive intermodulation, PIM, covariance matrix. The method also includes determining an uplink PIM signal subspace matrix based at least in part on an eigen-decomposition of the uplink PIM covariance matrix, the uplink PIM signal subspace matrix spanning an uplink PIM signal subspace. The method also includes determining a residual uplink signal vector at least partially compensated for PIM based at least in part on a spatial projection of a total received uplink signal vector onto the uplink PIM signal subspace.

According to this aspect, in some embodiments, the residual uplink signal vector is based at least in part on a product of a PIM eigen-cancellation matrix and the total received uplink signal vector, the PIM eigen-cancellation matrix being determined based at least in part on a difference between an identity matrix and a first matrix product of the uplink PIM signal subspace matrix multiplied by an Hermitian transpose of the uplink PIM signal subspace matrix. In some embodiments, determining the uplink PIM signal subspace matrix is performed less often than determining the residual uplink signal vector. In some embodiments, determining the residual uplink signal vector is performed prior to a transformation from an antenna space to a beam space. In some embodiments, determining the residual uplink signal vector is performed after a transformation from an antenna space to a beam space. In some embodiments, each column of the uplink PIM signal subspace matrix is a PIM eigenvector determined from one of the singular value decomposition and a heuristic decomposition of the uplink PIM covariance matrix. In some embodiments, the residual uplink signal vector is determined in the time domain using a channel bandwidth allocated for communication with at least one wireless device. In some embodiments, the residual uplink signal vector is determined in the frequency domain using a bandwidth that is one of equal to and less than a channel bandwidth allocated for communication with at least one wireless device. In some embodiments, determining the uplink PIM signal subspace matrix is performed separately for each of a plurality of polarizations of antennas of the network node. In some embodiments, determining the uplink PIM signal subspace matrix is performed in a radio unit of the network node.

According to another aspect, a network node includes processing circuitry configured to: determine an uplink passive intermodulation, PIM, covariance matrix; determine an uplink PIM signal subspace matrix based at least in part on an eigen-decomposition of the uplink PIM covariance matrix, the uplink PIM signal subspace matrix spanning an uplink PIM signal subspace; and determine a residual uplink signal vector at least partially compensated for PIM based at least in part on a spatial projection of a total received uplink signal vector onto the uplink PIM signal subspace.

According to this aspect, in some embodiments, the residual uplink signal vector is based at least in part on a product of a PIM eigen-cancellation matrix and the total received uplink signal vector, the PIM eigen-cancellation matrix being determined based at least in part on a difference between an identity matrix and a first matrix product of the uplink PIM signal subspace matrix multiplied by an Hermitian transpose of the uplink PIM signal subspace matrix. In some embodiments, determining the uplink PIM signal subspace matrix is performed less often than determining the residual uplink signal vector. In some embodiments, determining the residual uplink signal vector is performed prior to a transformation from an antenna space to a beam space. In some embodiments, determining the residual uplink signal vector is performed after a transformation from an antenna space to a beam space. In some embodiments, each column of the uplink PIM signal subspace matrix is a PIM eigenvector determined from one of the singular value decomposition and a heuristic decomposition of the uplink PIM covariance matrix. In some embodiments, the residual uplink signal vector is determined in the time domain using a channel bandwidth allocated for communication with at least one wireless device. In some embodiments, the residual uplink signal vector is determined in the frequency domain using a bandwidth that is one of equal to and less than a channel bandwidth allocated for communication with at least one wireless device. In some embodiments, determining the uplink PIM signal subspace matrix is performed separately for each of a plurality of polarizations of antennas of the network node. In some embodiments, determining the uplink PIM signal subspace matrix is performed in a radio unit of the network node.

According to another aspect, a method in a network node includes determining an uplink passive intermodulation, PIM, covariance matrix. The method also includes determining an uplink PIM signal subspace matrix based at least in part on identifying diagonal elements of the uplink PIM covariance matrix having a power exceeding a first threshold. When a number of identified diagonal elements falls below a second threshold, the method includes determining a residual uplink signal vector by attenuating elements of the total received uplink signal vector corresponding to the identified diagonal elements.

According to this aspect, in some embodiments, determining the uplink PIM signal subspace matrix is performed less often than determining the residual uplink signal vector. In some embodiments, determining the residual uplink signal vector is performed prior to a transformation from an antenna space to a beam space. In some embodiments, determining the residual uplink signal vector is performed after a transformation from an antenna space to a beam space. In some embodiments, the residual uplink signal vector is determined in the time domain using a channel bandwidth allocated for communication with at least one wireless device. In some embodiments, the residual uplink signal vector is determined in the frequency domain using a bandwidth that is equal or less than a channel bandwidth allocated for communication with at least one wireless device. In some embodiments, determining the uplink PIM signal subspace matrix is performed separately for each of a plurality of polarizations of antennas of the network node. In some embodiments, determining the uplink PIM signal subspace matrix is performed in a radio unit of the network node.

According to yet another aspect, a network node includes processing circuitry configured to: determine an uplink passive intermodulation, PIM, covariance matrix; determine an uplink PIM signal subspace matrix based at least in part on identifying diagonal elements of the uplink PIM covariance matrix having a power exceeding a first threshold; and when a number of identified diagonal elements falls below a second threshold, then determine a residual uplink signal vector by attenuating elements of the total received uplink signal vector corresponding to the identified diagonal elements.

According to this aspect, in some embodiments, determining the uplink PIM signal subspace matrix is performed less often than determining the residual uplink signal vector. In some embodiments, determining the residual uplink signal vector is performed prior to a transformation from an antenna space to a beam space. In some embodiments, determining the residual uplink signal vector is performed after a transformation from an antenna space to a beam space. In some embodiments, the residual uplink signal vector is determined in the time domain using a channel bandwidth allocated for communication with at least one wireless device. In some embodiments, the residual uplink signal vector is determined in the frequency domain using a bandwidth that is equal or less than a channel bandwidth allocated for communication with at least one wireless device. In some embodiments, determining the uplink PIM signal subspace matrix is performed separately for each of a plurality of polarizations of antennas of the network node. In some embodiments, determining the uplink PIM signal subspace matrix is performed in a radio unit of the network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for uplink passive intermodulation (PIM) eigen-cancellation according to principles set forth herein;

FIG. 8 is a flowchart of another example process in a network node for uplink PIM eigen-cancellation according to principles set forth herein; and

FIG. 9 is a diagram showing a projection of an uplink received vector onto an uplink PIM signal subspace.

### DETAILED DESCRIPTION

Before describing in detail example embodiments, it is noted that the embodiments reside primarily in combinations of apparatus components and processing steps related to an uplink passive intermodulation (PIM) eigen-canceller. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide an uplink passive intermodulation (PIM) eigen-canceller.

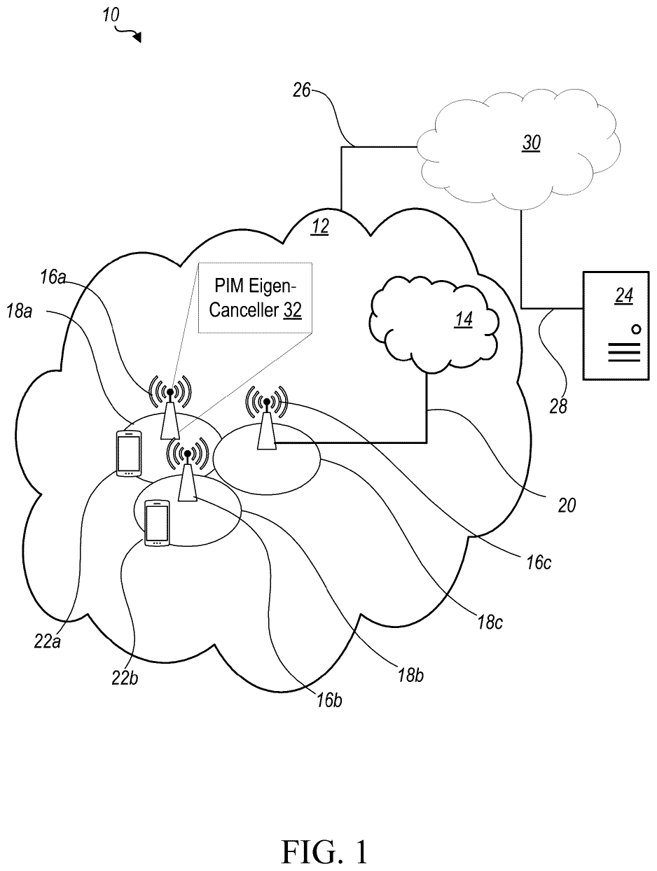

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a PIM eigen-canceller 32 which is configured to determine a residual uplink signal vector at least partially compensated for PIM based at least in part on a spatial projection of a total received uplink signal vector onto the uplink PIM signal subspace.

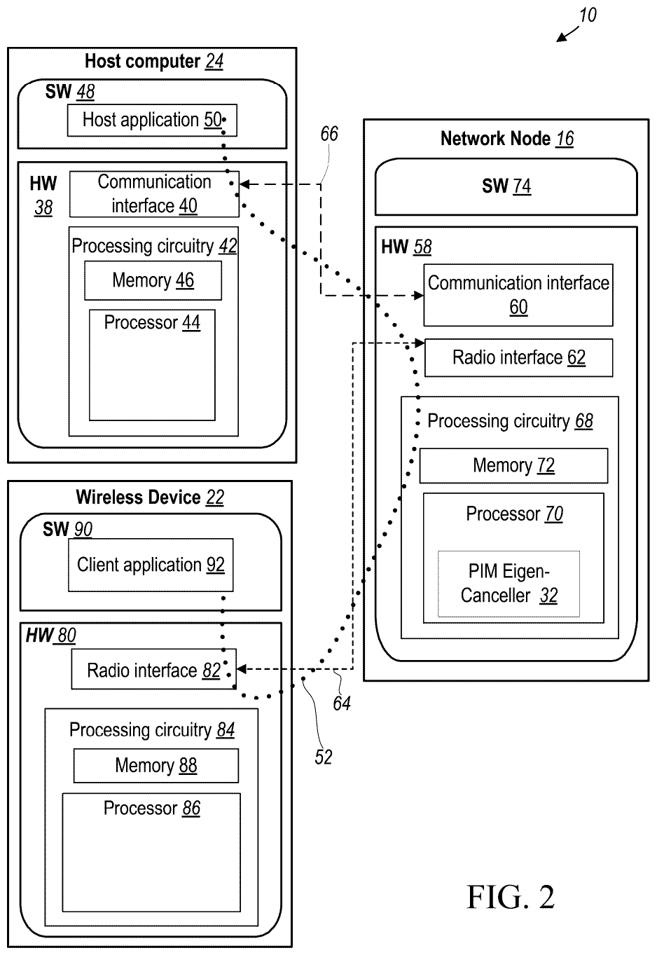

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a PIM eigen-canceller 32 which is configured to determine a residual uplink signal vector at least partially compensated for PIM based at least in part on a spatial projection of a total received uplink signal vector onto the uplink PIM signal subspace.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as PIM eigen-canceller 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

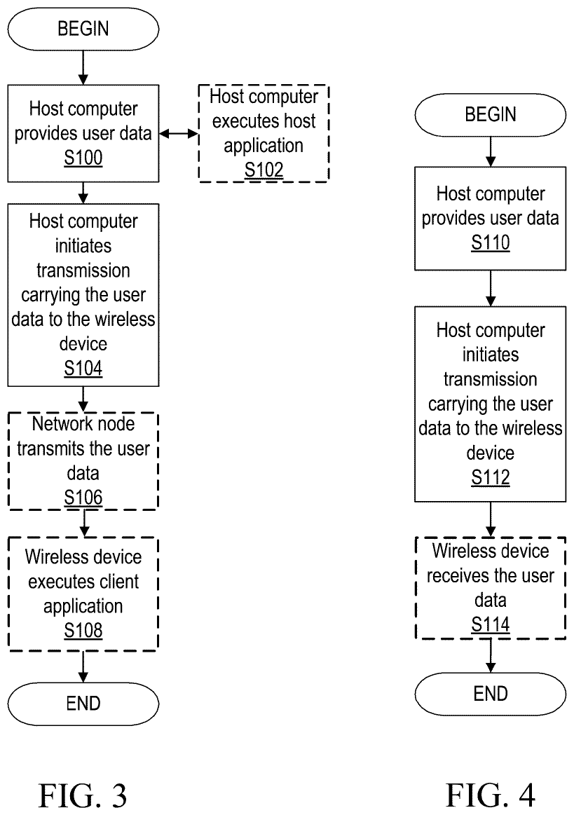

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

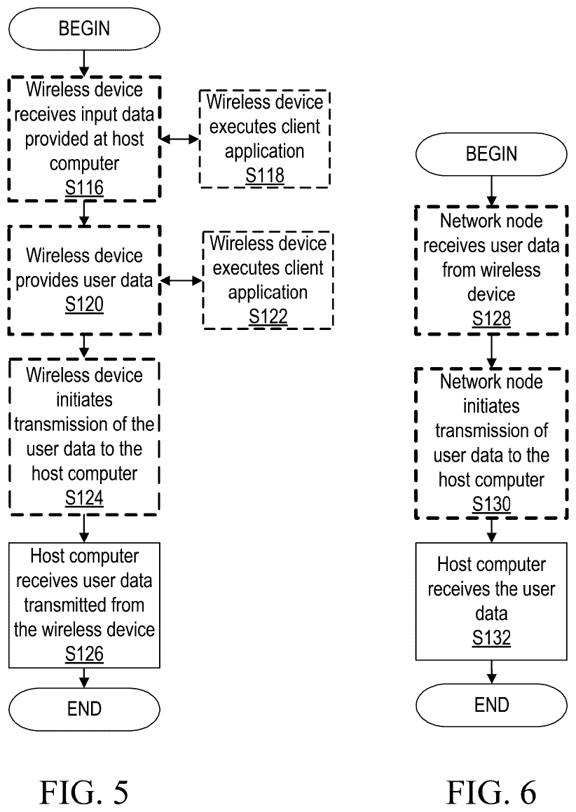

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

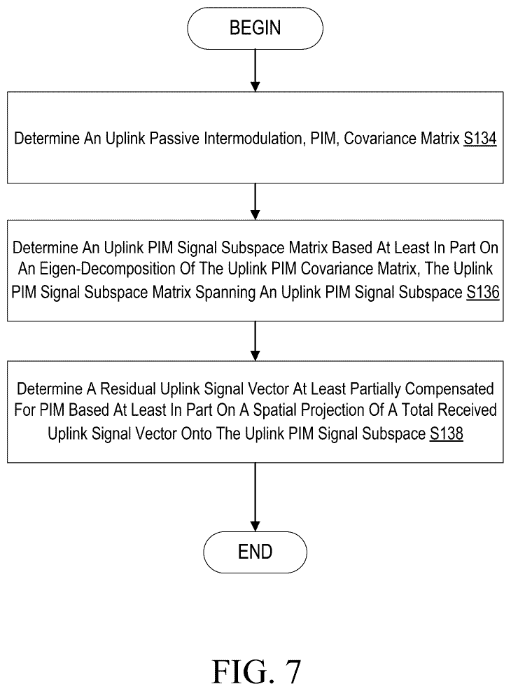

FIG. 7 is a flowchart of an example process in a network node 16 for uplink passive intermodulation (PIM) eigen-cancellation. One or more blocks described herein may be performed by one or more elements of network node 16 such as by one or more of processing circuitry 68 (including the PIM eigen-canceller 32), processor 70, radio interface 62 and/or communication interface 60. Network node 16 such as via processing circuitry 68 and/or processor 70 and/or radio interface 62 and/or communication interface 60 is configured to determine an uplink passive intermodulation, PIM, covariance matrix (Block S134). The process also includes determining an uplink PIM signal subspace matrix based at least in part on an eigen-decomposition of the uplink PIM covariance matrix, the uplink PIM signal subspace matrix spanning an uplink PIM signal subspace (Block S136). The process further includes determining a residual uplink signal vector at least partially compensated for PIM based at least in part on a spatial projection of a total received uplink signal vector onto the uplink PIM signal subspace (Block S138).

In some embodiments, the residual uplink signal vector is based at least in part on a product of a PIM eigen-cancellation matrix and the total received uplink signal vector, the PIM eigen-cancellation matrix being determined based at least in part on a difference between an identity matrix and a first matrix product of the uplink PIM signal subspace matrix multiplied by an Hermitian transpose of the uplink PIM signal subspace matrix. In some embodiments, determining the uplink PIM signal subspace matrix is performed less often than determining the residual uplink signal vector. In some embodiments, determining the residual uplink signal vector is performed prior to a transformation from an antenna space to a beam space. In some embodiments, determining the residual uplink signal vector is performed after a transformation from an antenna space to a beam space. In some embodiments, each column of the uplink PIM signal subspace matrix is a PIM eigenvector determined from one of the singular value decomposition of the uplink PIM covariance matrix. In some embodiments, the residual uplink signal vector is determined in the time domain using a channel bandwidth allocated for communication with at least one wireless device. In some embodiments, the residual uplink signal vector is determined in the frequency domain using a bandwidth that is one of equal to and less than a channel bandwidth allocated for communication with at least one wireless device. In some embodiments, determining the uplink PIM signal subspace matrix is performed separately for each of a plurality of polarizations of antennas of the network node. In some embodiments, determining the uplink PIM signal subspace matrix is performed in a radio unit of the network node.

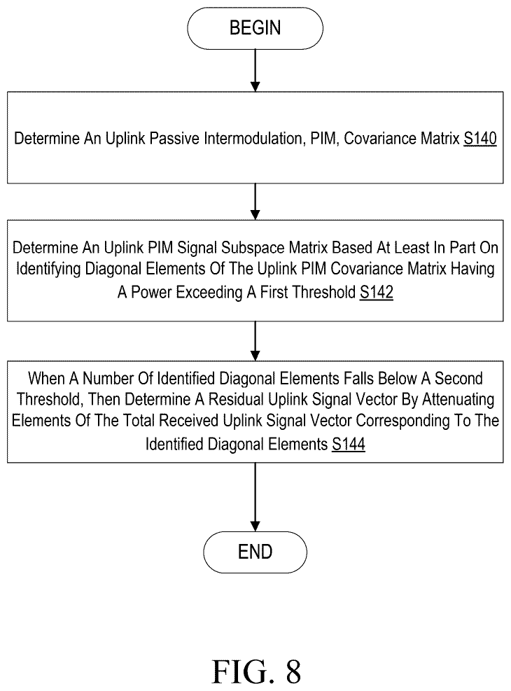

FIG. 8 is a flowchart of another example process in a network node 16 for uplink passive intermodulation (PIM) eigen-cancellation. One or more blocks described herein may be performed by one or more elements of network node 16 such as by one or more of processing circuitry 68 (including the PIM eigen-canceller 32), processor 70, radio interface 62 and/or communication interface 60. Network node 16 such as via processing circuitry 68 and/or processor 70 and/or radio interface 62 and/or communication interface 60 is configured to determine an uplink passive intermodulation, PIM, covariance matrix (Block S140). The method also includes determining an uplink PIM signal subspace matrix based at least in part on identifying diagonal elements of the uplink PIM covariance matrix having a power exceeding a first threshold (Block S142). When a number of identified diagonal elements falls below a second threshold, the method includes determining a residual uplink signal vector by attenuating elements of the total received uplink signal vector corresponding to the identified diagonal elements (Block S144).

In some embodiments, determining the uplink PIM signal subspace matrix is performed less often than determining the residual uplink signal vector. In some embodiments, determining the residual uplink signal vector is performed prior to a transformation from an antenna space to a beam space. In some embodiments, determining the residual uplink signal vector is performed after a transformation from an antenna space to a beam space. In some embodiments, the residual uplink signal vector is determined in the time domain using a channel bandwidth allocated for communication with at least one wireless device. In some embodiments, the residual uplink signal vector is determined in the frequency domain using a bandwidth that is equal or less than a channel bandwidth allocated for communication with at least one wireless device. In some embodiments, determining the uplink PIM signal subspace matrix is performed separately for each of a plurality of polarizations of antennas of the network node. In some embodiments, determining the uplink PIM signal subspace matrix is performed in a radio unit of the network node. Having described the general process flow of arrangements of the disclosure and having provided examples of hardware and software arrangements for implementing the processes and functions of the disclosure, the sections below provide details and examples of arrangements for uplink passive intermodulation (PIM) eigen-cancellation.

Some embodiments provide a base station with N antennas. A total received uplink signal vector r_{UL}∈ [symbol] _{N×1} may contain up to four contributions as shown in equation (1) below:

r_{UL}=r_{UE}+r_{intercell}+r_{PIM}+rₙₒᵢₛₑ (1)

where:
where:
r_{UE}∈ [symbol] ^{N×1} is the scheduled WD's contribution vector;
r_{intercell}∈ [symbol] _{N×1} is the total interference vector coming from WD's belonging to adjacent cells;
r_{PIM}∈ [symbol] ^{N×1} is the PIM vector; and
rₙₒᵢₛₑ∈ [symbol] _{N×1} is the noise vector.

The total received uplink signal covariance matrix R_{UL}∈ [symbol] _{N×N} may be expressed as:

$${R}_{UL} = E [ {r}_{UL} \cdot {r}_{UL}^{H} ] \qquad ( 2 )$$

where:
E [⋅] is the mathematical expectation operator; and
(⋅)^{H} is the Hermitian transpose operator.

The eigen-decomposition of the R_{UL} covariance matrix may resemble the following form:

$$( 3 )$$

$${R}_{UL} = [ {U}_{UE} \vert {U}_{intercell} \vert {U}_{PIM} \vert {U}_{Noise} ] \cdot [ \begin{matrix}{\sum }_{UE} & 0 & 0 & 0 \\ 0 & {\sum }_{intercell} & 0 & 0 \\ 0 & 0 & {\sum }_{PIM} & 0 \\ 0 & 0 & 0 & {\sum }_{Noise}\end{matrix} ] \cdot {[ {U}_{UE} \vert {U}_{intercell} \vert {U}_{PIM} \vert {U}_{Noise} ]}^{H}$$

where:
U_{UE}∈ [symbol] ^{N×K} corresponds to the K scheduled WD's eigenvectors;
U_{intercell}∈ [symbol] ^{N×M} is a matrix containing the M intercell interference eigenvectors;
U_{PIM}∈ [symbol] ^{N×P} corresponds to the P PIM eigenvectors;
U_{Noise}∈ [symbol] ^{N×(N-K-M-P)} is the noise subspace;
Σ_{UE} is a K×K diagonal matrix with the diagonal elements set to the K scheduled uplink WD's eigenvalues λ₀, . . . , λ_{K-1};
Σ_{intercell} is a M×M diagonal matrix with the diagonal elements set to the M intercell interference eigenvalues λ_{K}, . . . , λ_{K+M-1};
Σ_{PIM} is a P×P diagonal matrix with the diagonal elements set to the P intercell interference eigenvalues λ_{K+M}, . . . , λ_{K+M+P-1}; and
ΣNoise is a (N−K−M−P)×(N−K−M−P) diagonal matrix with the diagonal elements set to the (N−K−M−P) noise eigenvalues λ_{K+M+P}, . . . , λ_{N-1}.

The uplink PIM covariance matrix R_{PIM} may be acquired via the radio interface 62 and processing circuitry 68, including the PIM eigen-canceller 32, using known methods, summarized as follows:
Method 1: a method which may be used when a downlink signal is transmitted, but no users are scheduled in the uplink:
The uplink received signal covariance matrix is formed according to equation (2). Note that the OFDM resource elements that are used for the initial access such as the Physical Random-Access Channel (PRACH) may be excluded from this averaging process;
The R_{UL} covariance matrix contains the following contributions: noise, all interference sources including PIM, inter-cell interferences and any other interference;
Assuming that there is a PIM problem at the cellular site, and that the averaging process (either continuous or intermittent) spans a sufficiently long period, the dominant eigen components should represent the PIM contribution; and
The R_{UL} covariance matrix generated by this process may then be used as an estimate \hat{R}_{PIM} of the PIM covariance matrix;
Method 2: a method that uses the DL covariance matrix variations—due to either a power or a precoder change—to capture the UL PIM covariance matrix. Such variations may arise from a high-power DL symbol followed by a lower power DL symbol within the same Transmission Time Interval (TTI), for example. The contributions from the scheduled users, the intercell interferers and the noise may be expected to be similar in the uplink over two consecutive symbols. Thus, the PIM covariance matrix may be estimated by taking the difference between the two covariance matrices computed over these two symbols as illustrated in Equation (4) below:

$$\begin{matrix}{R}_{UL \_ HighPower} & = & {R}_{UE} + {R}_{intercell} + {R}_{noise} + {R}_{PIM} \\ {R}_{UL \_ LowPower} & = & {R}_{UE} + {R}_{intercell} + {R}_{noise} \\ Δ R & = & {R}_{UL \_ HighPower} - {R}_{UL \_ LowPower} \\ & = & {\hat{R}}_{PIM}\end{matrix} \qquad ( 4 )$$

Method 3: a method that implements a “per-antenna” PIM covariance matrix acquisition method (over frequency-domain subcarriers) which uses partially occupied uplink physical resource blocks (PRBs). Over distinct and staggered time instances, the base station receives UL signals across the entire band. In each time instant, i.e., OFDM symbol, only parts of the band may be populated with user traffic. This may be exploited to formulate a cost function which, when solved, reveals some frequency-domain PIM cancellation weights that may be applied on each antenna branch separately.

PIM covariance matrix acquisition methods above may use partially allocated bandwidth in any given uplink TTI, only retaining the PRBs where no user is scheduled to perform their processing.

The estimated uplink PIM covariance matrix \hat{R}_{PIM}∈ [symbol] _{N×N} may be eigen-decomposed via the PIM eigen-canceller 32, to produce the estimated uplink PIM signal subspace Û_{PIM}∈ [symbol] ^{N×P} formed by horizontally stacking the P PIM eigenvectors.

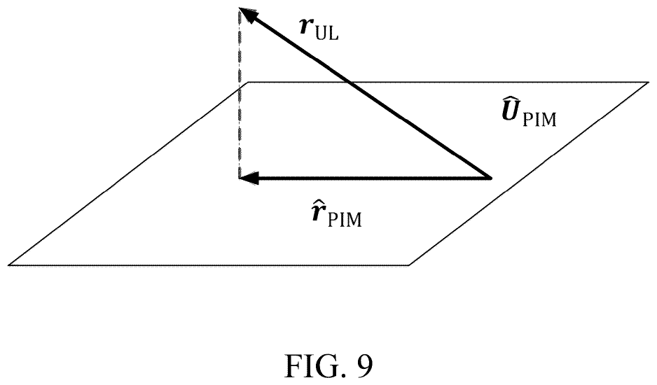

The contribution from the PIM sources, i.e., their received signal in the antenna domain, corresponds to the projection of the total received signal r_{UL} onto the estimated PIM signal subspace Û_{PIM} as illustrated in Equation (5) and FIG. 9:

$${\hat{r}}_{P I M} = {\hat{U}}_{P I M} \cdot {\hat{U}}_{P I M}^{H} \cdot {r}_{UL} \qquad ( 5 )$$

The residual quantity that is produced by subtracting the estimated PIM contribution from the total received signal corresponds to the estimated vectors from the scheduled WDs, the intercell interferers, and the noise:

$$\begin{matrix}{r}_{UL \_ residual} = {r}_{UL} - {\hat{r}}_{PIM} \\ = ( I - {\hat{U}}_{PIM} \cdot {\hat{U}}_{PIM}^{H} ) \cdot {r}_{UL} \\ = {\hat{r}}_{UE} + {\hat{r}}_{intercell} + {\hat{r}}_{noise}\end{matrix} \qquad ( 6 )$$

where I is the N×N identity matrix. The spatial projection from Equation (6) is referred to as a PIM eigen-canceller.

In some embodiments, the PIM eigen-canceller 32 may be implemented before any antenna space to beam space transformations such as a spatial Discrete Fourier Transform (DFT).

In some embodiments, when a minority of the elements of r_{UL} have significantly more PIM power than the majority of the elements, then the PIM covariance estimate and corresponding eigen analysis may be omitted. These elements may be attenuated or zeroed out from the received vector r_{UL}. In this scenario the covariance estimate and corresponding eigen-analysis may result in a similar outcome, but with more complexity.

In some embodiments, the PIM eigen-canceller 32 may be implemented in a Radio Unit (RU).

The PIM eigen-canceller 32 may be implemented in the time-domain using the entire channel bandwidth or in the frequency-domain using a smaller bandwidth resolution. In addition, the PIM eigen-canceller processing may combine the antennas from all polarizations or alternatively, it may be performed for each of the antenna polarization separately.

In some embodiments, the PIM eigenvectors refresh rate may be much slower than the NR/LTE OFDM symbol rate. Therefore, the PIM eigenvector acquisition methods disclosed herein have a low relative computational cost compared to that of the null-steering actuator.

In some embodiments, one or more of the methods described herein may be implemented in open radio access network (ORAN) Radio Units (O-RU).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| AAS | Advanced Antenna Systems |
| DFT | Discrete Fourier Transform |
| DL | Downlink |
| LTE | Long-Term Evolution |
| OFDM | Orthogonal Frequency-Division Multiplexing |
| O-RU | ORAN Radio Unit |
| NR | New Radio |
| PIM | Passive Inter-Modulation |
| PRACH | Physical Random-Access Channel |
| PRB | Physical Resource Block |
| RU | Radio Unit |
| TTI | Transmission Time Interval |
| UE | User Equipment |
| UL | Uplink |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node, the method comprising:
determining an uplink passive intermodulation, PIM, covariance matrix;
determining an uplink PIM signal subspace matrix based at least in part on an eigen-decomposition of the uplink PIM covariance matrix, the uplink PIM signal subspace matrix spanning an uplink PIM signal subspace; and
determining a residual uplink signal vector at least partially compensated for PIM based at least in part on a spatial projection of a total received uplink signal vector onto the uplink PIM signal subspace.

2. The method of claim 1, wherein the residual uplink signal vector is based at least in part on a product of a PIM eigen-cancellation matrix and the total received uplink signal vector, the PIM eigen-cancellation matrix being determined based on difference between an identity matrix and a first matrix product of the uplink PIM signal subspace matrix multiplied by an Hermitian transpose of the uplink PIM signal subspace matrix.

3. The method of claim 1, wherein determining the uplink PIM signal subspace matrix is performed less often than determining the residual uplink signal vector.

4. The method of claim 1, wherein determining the residual uplink signal vector is performed prior to a transformation from an antenna space to a beam space.

5. The method of claim 1, wherein determining the residual uplink signal vector is performed after a transformation from an antenna space to a beam space.

6. The method of claim 1, wherein each column of the uplink PIM signal subspace matrix is a PIM eigenvector determined from one of the singular value decomposition and a heuristic decomposition of the uplink PIM covariance matrix.

7. The method of claim 1, wherein the residual uplink signal vector is determined in the time domain using a channel bandwidth allocated for communication with at least one wireless device.

8. The method of claim 1, wherein the residual uplink signal vector is determined in the frequency domain using a bandwidth that is one of equal to and less than a channel bandwidth allocated for communication with at least one wireless device.

9. The method of claim 1, wherein determining the uplink PIM signal subspace matrix is performed separately for each of a plurality of polarizations of antennas of the network node.

10. The method of claim 1, wherein determining the uplink PIM signal subspace matrix is performed in a radio unit of the network node.

11. A network node comprising processing circuitry configured to:
determine an uplink passive intermodulation, PIM, covariance matrix;
determine an uplink PIM signal subspace matrix based at least in part on an eigen-decomposition of the uplink PIM covariance matrix, the uplink PIM signal subspace matrix spanning an uplink PIM signal subspace; and
determine a residual uplink signal vector at least partially compensated for PIM based at least in part on a spatial projection of a total received uplink signal vector onto the uplink PIM signal subspace.

12-20. (canceled)

21. A method in a network node, the method comprising:
determining an uplink passive intermodulation, PIM, covariance matrix;
determining an uplink PIM signal subspace matrix based at least in part on identifying diagonal elements of the uplink PIM covariance matrix having a power exceeding a first threshold; and
when a number of identified diagonal elements falls below a second threshold, then determining a residual uplink signal vector by attenuating elements of the total received uplink signal vector corresponding to the identified diagonal elements.

22. The method of claim 21, wherein determining the uplink PIM signal subspace matrix is performed less often than determining the residual uplink signal vector.

23. The method of claim 21, wherein determining the residual uplink signal vector is performed prior to a transformation from an antenna space to a beam space.

24. The method of claim 21, wherein determining the residual uplink signal vector is performed after a transformation from an antenna space to a beam space.

25. The method of claim 21, wherein the residual uplink signal vector is determined in the time domain using a channel bandwidth allocated for communication with at least one wireless device.

26. The method of claim 21, wherein the residual uplink signal vector is determined in the frequency domain using a bandwidth that is equal or less than a channel bandwidth allocated for communication with at least one wireless device.

27. The method of claim 21, wherein determining the uplink PIM signal subspace matrix is performed separately for each of a plurality of polarizations of antennas of the network node.

28. The method of claim 21, wherein determining the uplink PIM signal subspace matrix is performed in a radio unit of the network node.

29-36. (canceled)
